(19) United States
(12) Patent Application Publication
(10) Pub. No.: US 2016/0039340 A1
(43) Pub. Date: Feb. 11, 2016

(54) Selective proximity detection system and method

(71) Applicant: Q-Track Corporation, Huntsville, AL (US)

(72) Inventors: Hans Gregory Schantz, Big Cove, AL (US); Christopher David Pittman, Huntsville, AL (US); James Lee Richards, Fayetteville, TN (US); Stephen A. Werner, Huntsville, AL (US)

(21) Appl. No.: 14/919,113

(22) Filed: Oct. 21, 2015

Related U.S. Application Data
(63) Continuation-in-part of application No. 12/834,821, filed on Jul. 12, 2010, now Pat. No. 8,922,440.
Application No. 12/834,821 is a continuation-in-part of application No. 11/473,595, filed on Jun. 23, 2006, now Pat. No. 7,755,552.
Application No. 11/473,595 is a continuation-in-part of application No. 11/272,533, filed on Nov. 10, 2005, now Pat. No. 7,307,595.
(60) Provisional application No. 60/637,779, filed on Dec. 21, 2004.

(51) Int. Cl. B60Q 9/00

(52) U.S. Cl. CPC B60Q 9/008

(57) ABSTRACT

The present invention pertains to a selective proximity detection system. A selective proximity detection system comprises at least one proximity tag, a plurality of sensor nodes, and at least one alert node. A sensor nodes comprises a proximity detector capable of detecting proximity with respect to the proximity tag, and a motion detector. In a preferred embodiment, a motion detector is an infrared detector. In alternate embodiments, a motion detector may employ video, radar motion sensing, or sensing of scattered RF signals, preferably FM broadcast signals whose half wavelength is comparable in dimension to the height of a typical person. In a preferred embodiment, a proximity detector is a NFER locator-receiver and a proximity tag is a NFER tag transmitter. In alternate embodiments, a proximity detector may employ ZigBee, WiFi, Bluetooth, passive scattering of ambient RF signals or other means of proximity detection. A sensor node conveys motion detection data and proximity detection data to an alert mode via a datalink. An alert node selects from among a variety of alert responses based upon the motion detection data and proximity detection data.

### BACKGROUND

1. Field of the Invention

The disclosures herein relate generally to proximity detection and collision avoidance systems.

2. Background of the Invention

Each year, there are tens of thousands of injuries related to forklifts. Forklift accidents are a leading cause of occupational injuries. In 2013, there were 70 forklift fatalities. According to 2008 data from the U.S. Department of Labor's Bureau of Labor Statistics, the number one cause of lift truck related work fatalities is pedestrians being struck by a vehicle. Industrial accidents are a major cause of workplace injury. Lack of situational awareness can result in collisions between industrial equipment, like forklifts, or collisions between pedestrians and industrial equipment. In short, there exists a significant need for advances in proximity detection and collision avoidance systems.

### BRIEF SUMMARY OF THE INVENTION

The present invention pertains to a selective proximity detection system. A selective proximity detection system comprises at least one proximity tag, a plurality of sensor nodes, and at least one alert node. A sensor nodes comprises a proximity detector capable of detecting proximity with respect to the proximity tag, and a motion detector. In a preferred embodiment, a motion detector is an infrared detector. In alternate embodiments, a motion detector may employ video, radar motion sensing, or sensing of scattered RF signals, preferably FM broadcast signals whose half wavelength is comparable in dimension to the height of a typical person. In a preferred embodiment, a proximity detector is a NFER locator-receiver and a proximity tag is a NFER tag transmitter. In alternate embodiments, a NFER locator-receiver may employ a directional electrically small antenna array. In alternate embodiments, a proximity detector may employ ZigBee, WiFi, Bluetooth, passive scattering of ambient RF signals or other means of proximity detection. Also in a preferred embodiment, the proximity detector is normally off until the microprocessor turns the proximity detector on in response to a motion detection by the motion detector, thus saving power and maximizing battery life. A sensor node conveys motion detection data and proximity detection data to an alert mode via a datalink. In preferred embodiments, a datalink is a low-power Bluetooth data link.

An alert node selects from among a variety of alert responses based upon the motion detection data and proximity detection data. The alert node employs a warning device such as a light or audible alarm which may be either co-located on incorporated in the alert node or remote from the alert node.

In preferred embodiments, a selective proximity detection system employs a remote digital device to configure and/or monitor the selective proximity detection system.

In alternate embodiments, a selective proximity detection system employs a process comprising the steps of
1) setting, by a user, a plurality of detection thresholds,
2) transmitting, by a station, a signal,
3) receiving, by the proximity detection system, the signal
4) measuring, by the proximity detection system, a plurality of received signal characteristics,
5) comparing, by the proximity detection system, the plurality of received signal characteristics with a baseline value, and
6) employing, by the proximity detection system, the plurality of thresholds to determine an appropriate alert.

The signal may be an FM broadcast band signal and the plurality of thresholds may include thresholds to distinguish between pedestrians and heavy equipment like forklifts.

In still further alternate embodiments, a selective proximity detection system determines a location of a scatterer by the steps of:
1) generating a plurality of calibration data sets, each calibration data set of said plurality of calibration data sets generated by:
   a) transmitting, by a station, a calibration transmission,
   b) receiving, by a locator-receiver, the calibration transmission,
   c) measuring, by the locator-receiver, a plurality of received signal characteristics of the calibration transmission to generate said calibration data set,
   d) associating, by an associator, said calibration data set with the known position of a scatterer,
2) generating a positioning data set, said positioning data set generated by:
   a) transmitting, by the station, a location transmission,
   b) receiving, by the locator-receiver, the location transmission,
   c) measuring, by the locator-receiver, a plurality of received signal characteristics of the location transmission to generate said positioning data set associated with the unknown position, and
3) determining, by an information handling system, said unknown position of a scatterer based on a comparison of said plurality of calibration data sets to said positioning data set.

The calibration and location transmissions may involve FM broadcast band signals, and the received signal characteristics may include a plurality of signal amplitudes.

Additional advantages of the invention will become evident on review of the drawings and specification.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1A presents a preferred embodiment proximity tag.

FIG. 1B depicts internal configuration of a preferred embodiment proximity tag.

FIG. 1C shows an alternate embodiment proximity tag.

FIG. 1D provides a block diagram of a proximity tag transmitter.

FIG. 2A shows a preferred embodiment sensor node.

FIG. 2B depicts internal configuration of a preferred embodiment sensor node.

FIG. 2C shows a first alternate embodiment sensor node.

FIG. 2D provides a second alternate embodiment sensor node.

FIG. 2E presents internal configuration of a second alternate embodiment sensor node.

FIG. 2F displays a block diagram of a sensor node.

FIG. 3A presents a preferred embodiment warning light for use with an alert node.

FIG. 3B shows a preferred embodiment alert node.

FIG. 3C displays an alternate embodiment alert node.

FIG. 3D provides a block diagram of a preferred embodiment alert node incorporating a warning device.

FIG. 3E depicts a block diagram of an alternate embodiment alert node with a remote warning device.

FIG. 4A shows a system diagram of a selective proximity detection system.

FIG. 4B presents a system layout diagram of a selective proximity detection system.

FIG. 5A displays a typical logic diagram for a selective proximity detection system with two sensor nodes.

FIG. 5B presents a typical logic diagram for a selective proximity detection system with three sensor nodes.

FIG. 6A shows a three element directional electrically-small antenna array.

FIG. 6B presents a two element directional electrically-small antenna array.

FIG. 6C depicts an in-phase pattern for a two element directional electrically-small antenna array.

FIG. 6D provides an opposing phase pattern for a two element directional electrically-small antenna array.

FIG. 6E displays an end-fire phase pattern for a two element directional electrically-small antenna array.

FIG. 7A shows a simulation of radio waves interacting with a notional structure.

FIG. 7B presents a sketch of radio waves interacting with a structure and then being received by a locator.

FIG. 7C depicts a sketch of radio waves interacting with a structure and a scatterer and then being received by a locator.

FIG. 7D provides an alternate embodiment selective proximity detection system comprising a smart phone and an antenna.

FIG. 7E offers a first block diagram of an alternate embodiment selective proximity detection system comprising a smart phone and an antenna.

FIG. 7F displays a second block diagram of an alternate embodiment selective proximity detection system comprising a smart phone and an antenna.

FIG. 8 presents a first alternate embodiment process flow diagram for a selective proximity detection system.

FIG. 9 presents a second alternate embodiment process flow diagram for a selective proximity detection system.

### DETAILED DESCRIPTION OF THE PREFERRED EMBODIMENTS

### Overview of the Invention

Selective Proximity Detection System A selective proximity detection system helps avoid collisions between industrial equipment as well as collisions between pedestrians and industrial equipment. In a preferred embodiment, a selective proximity detection system comprises a plurality of proximity tag transmitters, a plurality of sensor nodes, and a plurality of alert nodes.

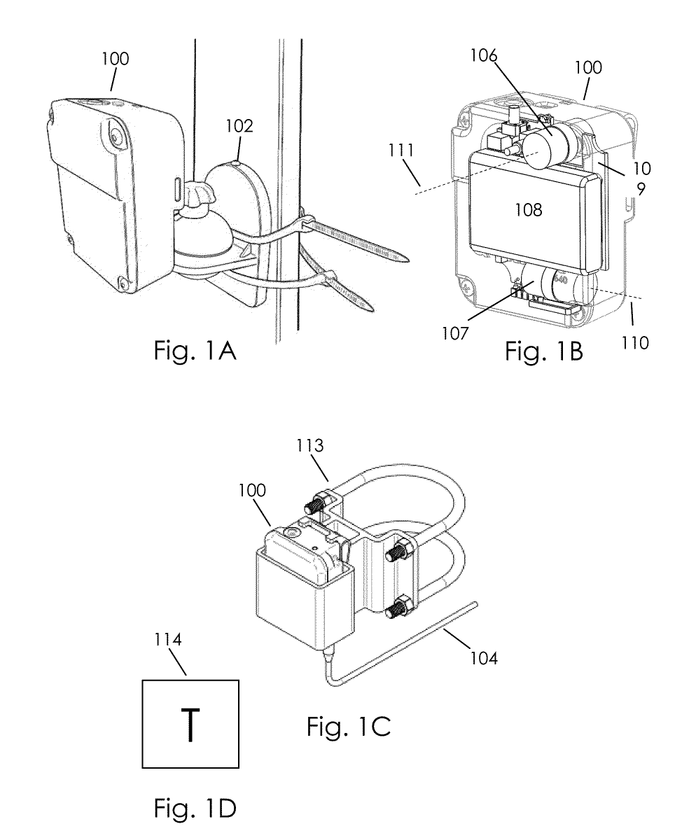

FIG. 1A presents a preferred embodiment proximity tag 100. The proximity tag 100 may also be referred to as the proximity tag transmitter 100. The proximity tag 100 transmits a radio frequency (RF) signal that allows a sensor node 200 to detect when an associated pedestrian or piece of industrial equipment 415 is proximal to the sensor node 200. In a preferred embodiment, a proximity tag transmitter 100 further includes a mechanical mount 102 for attachment to industrial equipment 415 and an external power connection 103 for interfacing to industrial equipment. In alternate embodiments, a tag transmitter 100 may be carried by a pedestrian 414.

FIG. 1B depicts internal configuration of the preferred embodiment proximity tag 100. The preferred embodiment proximity tag 100 further comprises a first magnetic antenna 106 with axis 111, a second magnetic antenna 107 with axis 110, an optional battery 108, and a transmitter printed circuit board (PCB) 109. In a preferred embodiment, electrical power is supplied to proximity tag 100 via an external power connection. First magnetic antenna 106 and second magnetic antenna 107 are arranged at opposite or extreme ends of preferred embodiment proximity tag 100, separated by battery 108 so as to minimize mutual coupling between first magnetic antenna 106 and second magnetic antenna 107. First antenna axis 110 and second antenna axis 111 are mutually orthogonal with respect to each other. These orthogonal antennas may be fed in phase quadrature to yield a quasi-isotropic field-of-view as further disclosed in Applicant's prior disclosures.

Applicants discovered that orthogonal magnetic antennas offer unique advantages for transmission and reception in real-time location systems, particularly Near-Field Electromagnetic Ranging (NFER) systems and in other applications like proximity detection. Details may be found in “Near-field location system and method,” (Ser. No. 11/272,533, filed Nov. 10, 2005, now U.S. Pat. No. 7,307,595, issued Dec. 11, 2007). Additional compact antenna designs are shown in applicant's “Space efficient magnetic antenna system,” (Ser. No. 11/473,595, filed Jun. 22, 2006, now U.S. Pat. No. 7,755,552 issued Jul. 13, 2010). Other antenna concepts of value in an RTLS and elsewhere are disclosed in Applicant's co-pending “Planar antenna system,” (Ser. No. 12/857,528, filed Aug. 16, 2010, now U.S. Pat. No. 8,436,780 issued May 7, 2013), and “Space efficient magnetic antenna method,” (Ser. No. 12/834,821, filed Jul. 12, 2010, now U.S. Pat. No. 8,922,440 issued Dec. 30, 2014). All these disclosures are hereby incorporated by reference.

FIG. 1C shows an alternate mechanical mount 113 for proximity tag 100. The alternate 113 further includes an external power connection 104 for interfacing to the power supply of associated industrial equipment like forklift 415.

FIG. 1D provides a block diagram 114 of a proximity tag transmitter. In a preferred embodiment, a proximity tag transmitter is a near-field electromagnetic ranging (NFER) transmitter as referenced in the previous and subsequent disclosures.

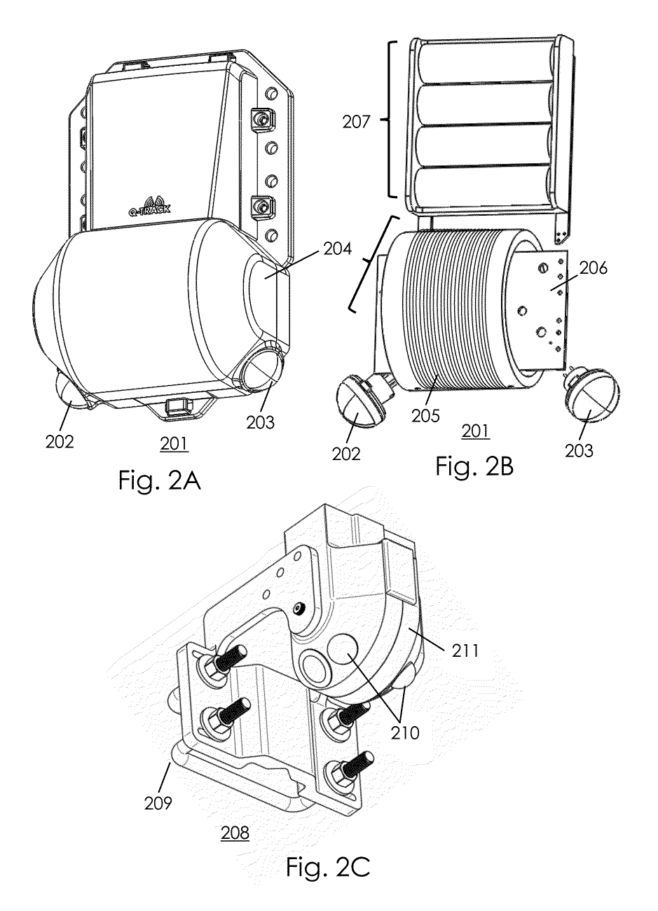

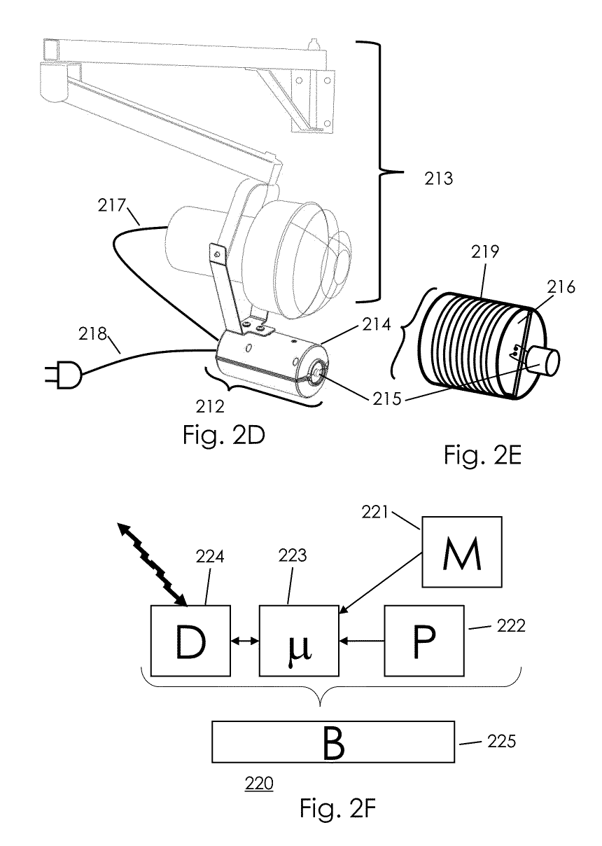

FIG. 2A shows a preferred embodiment sensor node 201. The preferred embodiment sensor node 201 further comprises a plurality of motion detectors (like first PIR sensor 202 and second PIR sensor 203) and a proximity detector 204. The proximity detector 204 may be a NFER receiver or other device for determining proximity of the proximity tag transmitter 100. In a preferred embodiment a motion detector is an infrared (IR) sensor (like first PIR sensor 202 and second PIR sensor 203) capable of determining motion through changes in IR radiation within a field of view. In alternate embodiments, a motion detector may be a video sensor, a Doppler radar, a Locator relying on changes in RF scattering, or other motion sensing device.

FIG. 2B depicts internal configuration of a preferred embodiment sensor node 201. The proximity detector 204 is a NFER receiver further comprising a magnetic antenna 205 and RF receiver circuits implemented on a sensor PCB 206. Sensor PCB 206 is oriented so as to block a minimum of the cross-sectional area of magnetic antenna 219 so as to have minimal impact on the sensitivity of magnetic antenna 219. The first PIR sensor 202 and the second PIR sensor 203 are also electrically connected to the sensor PCB 206. A preferred embodiment sensor node 201 further includes a plurality of batteries 207. Sensor PCB 206 is optimized for operation of a long time without an external power supply. Power consumption is minimized by leaving the sensor node and proximity detector in a sleep mode until a motion detection occurs, at which point the proximity detector powers up to check for the presence of a proximity tag. In alternate embodiments, magnetic antenna 205 may be replaced with a directive electrically small antenna array 600.

FIG. 2C shows a first alternate embodiment sensor node 208. The first alternate embodiment sensor node 208 further comprises mechanical mount 209 well suited for attachment to a rack or support structure commonly found in logistics facilities, a plurality of PIR motion detectors 210, and an alternate proximity detector 211.

FIG. 2D provides a second alternate embodiment sensor node 212. The second alternate embodiment sensor node 212 mounts to a dock light 213. Sensor node 212 further includes a proximity detector 214 and a motion sensor, PIR detector 215. Dock light 213 receives electrical power controlled by the second alternate embodiment sensor node 212 via electric connection 217. The second alternate embodiment sensor node 212 receives power via electrical connection 218. The second alternate embodiment sensor node 212 can thus control the operation of dock light 213 in response to motion and proximity detections according to rules defined by a user, in addition to interfacing with an alert node (like alert node 302). Rules may include the amount of time to remain on after detecting motion or proximity within a trailer at a dock, for instance.

FIG. 2E presents internal configuration of the second alternate embodiment sensor node 212. The proximity detector 214 is a NFER receiver further comprising a magnetic antenna 219 and RF receiver circuits implemented on a sensor PCB 216. In alternate embodiments, magnetic antenna 219 may be replaced by a directive electrically small antenna array 600.

FIG. 2F displays a block diagram 220 of a sensor node. A sensor node comprises a plurality of motion detectors (M) 221, a plurality of proximity detectors (P) 222, a microprocessor (p) 223, a data link (D) 224, and a battery (B) 225. A microprocessor 223 captures detection data from a motion detector 221 and/or a proximity detector 222 and relays detection data via a data link 224 to a plurality of alert nodes like alert node 302. A microprocessor 223 may also apply a time window to a motion detection to ensure that the motion detection or proximity detection remains active for typical periods of time during which the pedestrian (like pedestrian 414) or desired object whose motion is to be detected might remain motionless. Thus, in a preferred embodiment, the proximity detector 222 is normally off until the microprocessor 223 turns it on in response to a motion detection by the motion detector 221. In a preferred embodiment, the sensor node of block diagram 220 is a battery-operated device, so the data link 224 is preferably a low-power Bluetooth or other low-power data link.

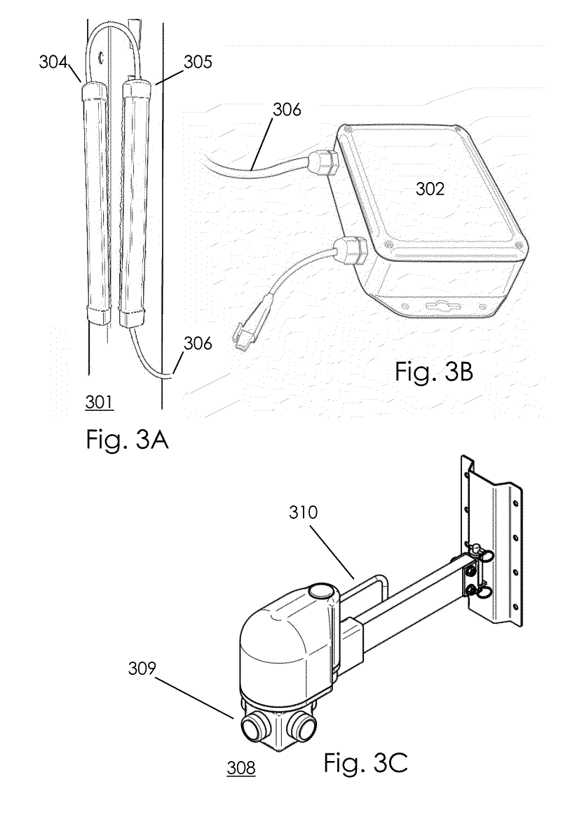

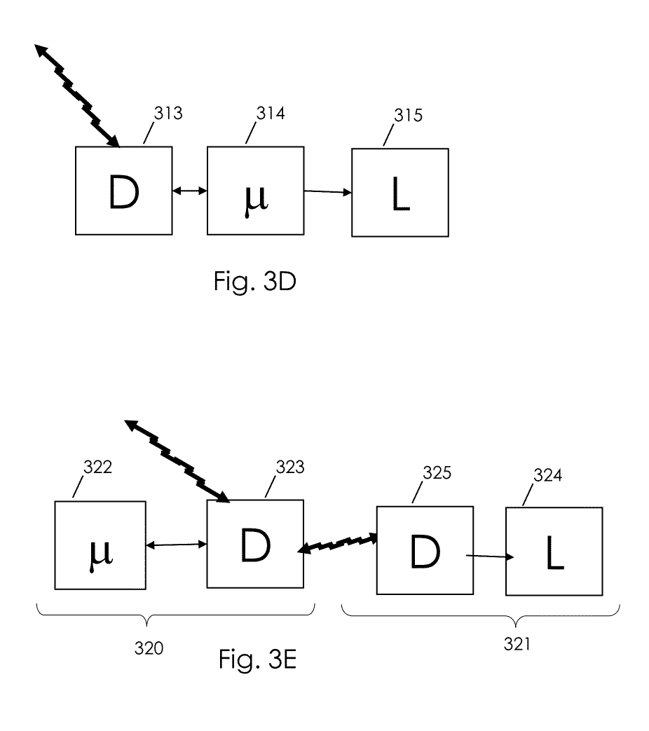

FIG. 3A presents a preferred embodiment warning light 301 for use with an alert node 302. The preferred embodiment warning light 301 comprises a plurality of LED light strips like first LED light 304 and second LED light 305. The preferred embodiment warning light 301 may be placed with one of a plurality of LED lights pointing in one direction and another pointing in another direction so as to maximize visibility. For instance the first LED light 304 and the second LED light 305 may be mounted so as to face different directions at a corner or different directions at a portal, pass through, doorway, or loading dock.

FIG. 3B shows a preferred embodiment alert node 302. The preferred embodiment alert node 302 connects to the preferred embodiment warning light 301 via electrical connection 306. In alternate embodiments, electrical connection 306 may be a wireless link and the preferred embodiment warning light 301 may be a battery operated device. The preferred embodiment alert node 302 receives signals from a plurality of sensor nodes (like sensor node 201, sensor node 208, sensor node 212, or the sensor node of block diagram 220). Then the preferred embodiment alert node 302 applies an algorithm to determine whether or not to provide an alert by illuminating a plurality of warning lights (like warning light 301), by sounding an audible alarm, or by conveying alert information to another device or user for further action.

FIG. 3C displays an alternate embodiment alert node 308. The alternate embodiment alert node 308 further comprises an integrated warning light 309 and an external power connection 310.

FIG. 3D provides a block diagram of a preferred embodiment alert node incorporating a warning device. The preferred embodiment alert node 312 comprises a datalink (D) 313, a microprocessor (μ) 314 (embedded within alert node 302), and a warning device or light (L) 315 such as warning light 301. In alternate embodiments, a warning device 315 may include audio or other warning means instead of or in addition to a light.

FIG. 3E depicts a block diagram of an alternate embodiment alert node 320 with a remote warning device 321. The alternate embodiment alert node 320 comprises a datalink (D) 323, and a microprocessor (μ) 322. The alternate embodiment alert node 320 further comprises a plurality of warning devices like warning light 321. The warning light 321 further comprises a light (L) 324 and a datalink (D) 325.

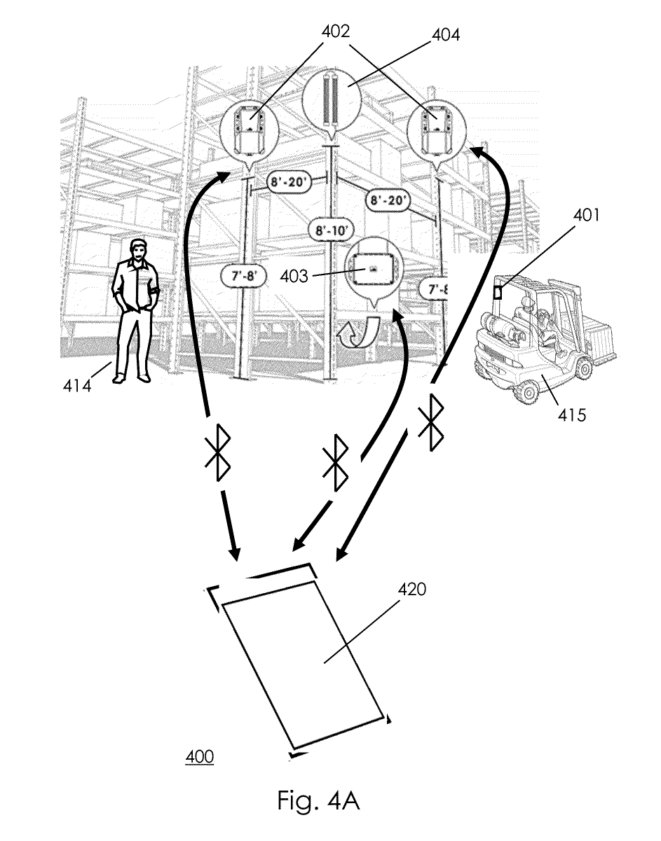

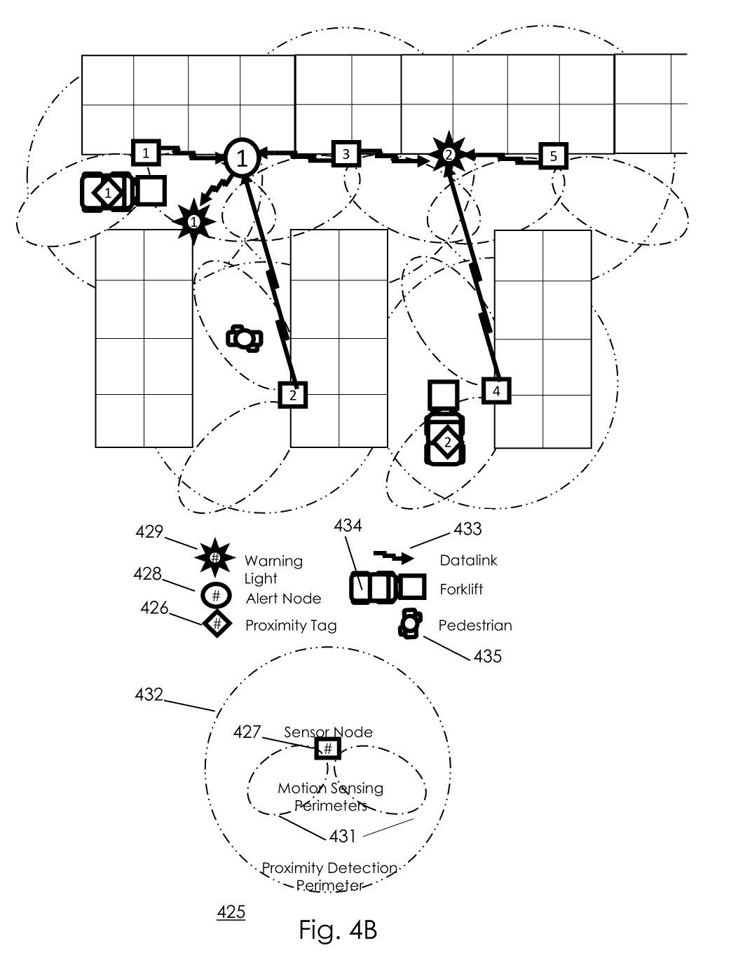

FIG. 4A shows a system diagram of a selective proximity detection system 400. A selective proximity detection system 400 comprises a plurality of proximity tag transmitters 401, a plurality of sensor nodes 402, and a plurality of alert nodes 403 and warning lights 404. The proximity tag transmitter 401 may be attached to industrial equipment like forklift 415 or in alternative embodiments carried by a pedestrian like pedestrian 414.

A significant advantage of the selective proximity detection system 400 is that workers, like pedestrian 414, do not need to carry any device in order to be warned regarding a potential collision with heavy equipment like forklift 415. Thus, the selective proximity detection system 400 protects workers, truck drivers, and facility guests without requiring them to remember to use, carry, or employ some device. The selective proximity detection system 400 offers significant advantages over prior art systems that require workers, guests, and other pedestrians to carry a device in order to be protected.

In addition, because the selective proximity detection system 400 can identify when a motion detection correlates to a proximity detection of heavy equipment like forklift 415, it triggers an alert or warning only when heavy equipment is present, and not when two pedestrians approach a corner or intersection. This selectivity offers substantial advantages over prior art systems that rely on motion detection alone and therefore have a significant problem with unnecessary alerts for pedestrian-pedestrian interactions. The selective proximity detection system 400 thus avoids “warning fatigue” that may lead to over stimulated workers ignoring an alert since so many alerts are false alarms in prior art motion detection only systems.

Remote digital device 420 allows a user to configure selective proximity detection system 400 via datalinks to component devices like sensor nodes 402, and a alert node 403. In a preferred embodiment, remote digital device 420 is a tablet or smartphone employing a Bluetooth data link in preferred embodiments. Detection thresholds, ranges, alert modes, and algorithms may be configured to suit a users' particular deployment needs. A Bluetooth data link may further employ encryption or other security measures to avoid unauthorized tampering with settings and configuration. Further, remote digital device 420 enables a user to monitor battery status and other critical parameters of the selective proximity detection system 400.

FIG. 4A also shows representative dimensions and arrangement of a typical deployment including representative dimensions (in feet) around a corner in a logistics environment. These typical deployment dimensions are presented for illustration and general guidance regarding typical deployments and should not be construed so as to exclude a wide range of other possible deployments in different geometries.

FIG. 4B presents a system layout diagram of a selective proximity detection system 425. The selective proximity detection system 425 comprises a plurality of proximity tag transmitters 426, a plurality of sensor nodes 427, and a plurality of alert nodes 428 and warning lights 429 each of which are denoted by a distinctive icon and identifying number. The sensor nodes 427 are characterized by a plurality of motion sensing perimeters 431 within which a motion detector detects motion, and a proximity detection perimeter 432 within with a proximity detector detects proximity. The proximity detection perimeter 432 typically approximates a circle, but in alternate embodiments employing directive electrically-small antennas (like directive electrically small array 600), the proximity detection perimeter 432 may exhibit enhanced range in a particular direction. The alert node 428 connects via a plurality of datalinks 433 to the plurality of sensor nodes 427. For instance, alert node #1 receives detection data from sensor node #1, sensor node #2, and sensor node #3.

In a typical deployment of a preferred embodiment, a piece of industrial equipment (such as forklifts 433) will have associated proximity tags 426. If an alert node 428 receives motion detection data from a sensor node 427 and proximity detection data from a different sensor node 427, an alert node 428 provides warning of a potential pedestrian-forklift collision by illuminating a warning light 429 with a first pattern (for instance, solid or continuous on). If an alert node 428 receives proximity detection data from two or more sensor nodes 427, an alert node provides warning of a potential forklift-forklift collision by illuminating a warning light 429 with a second pattern (for instance, flashing). Motion detection alone from different sensors will not trigger an alert.

In the example of FIG. 4B, a forklift 434 with associated proximity tag #1 triggers a proximity detection at sensor node #1. A pedestrian 435 triggers a motion detection at sensor node #2. Alert node #1 receives a proximity detection from sensor node #1 and a motion detection from sensor node #2 and triggers warning light #1 to alert the forklift driver and pedestrian of a potential hazard.

A second forklift with associated proximity tag #2 triggers a proximity detection at sensor node #4. Alert node #2 receives a proximity detection from sensor node #4, but in the absence of any addition detections, does not trigger associated warning light #2. Sensor nodes may be associated with a plurality of alert nodes. For instance, alert node #1 and alert node #2 both receive detection data from sensor node #3.

The selective proximity detection system 425 is selective in that it can provide different alerts or warnings based on the nature of a potential collision—one alert response to aid forklift drivers to avoid a forklift-forklift collision, a different alert response to aid a forklift driver and pedestrian to avoid a forklift-pedestrian collision, and an alert response to aid pedestrians to avoid collisions with each other. In addition, a selective proximity detection system can be configured to avoid alerting for a potential pedestrian-pedestrian collision. This “null” alert response avoids the warning fatigue, loss of awareness, and potential for accidents associated with a system that delivers excess false alarms. Thus a pedestrian knows that a particular alert response means a forklift is present and can take appropriate action to avoid injury. A selective proximity detection system 425 can provide a range of warning levels and different alert responses to avoid false alerts and help ensure that alerts are taken seriously and not ignored due to excessive false alarms.

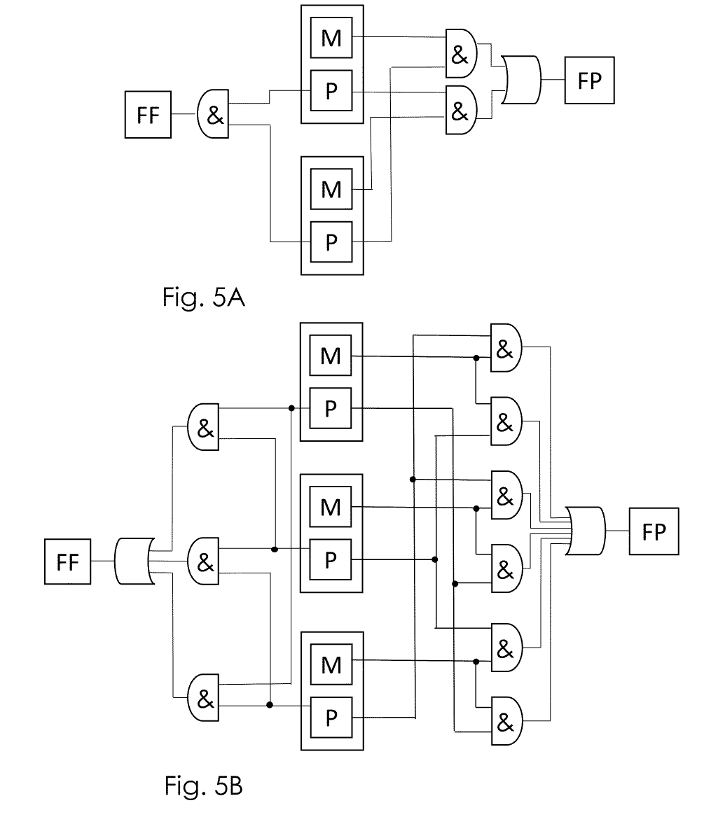

FIG. 5A displays a first typical logic diagram 500 for a selective proximity detection system with two sensor nodes. Motion detection (M), and proximity detection (P), yield either a forklift-forklift warning (FF) or a forklift-pedestrian warning (FP) combined according to logical ands (&) as shown. Logic diagram 500 assumes a forklift has an associated proximity tag.

FIG. 5B presents a second typical logic diagram 501 for a selective proximity detection system with three sensor nodes. Here again, Motion detection (M), and proximity detection (P), yield either a forklift-forklift warning (FF) or a forklift-pedestrian warning (FP) combined according to logical ands (&) as shown. In alternate embodiments, the forklift-forklift warning and forklift-pedestrian warning may be identical with no warning for a potential pedestrian-pedestrian collision. A wide variety of alternate algorithms including detection thresholds may be selected to optimize performance, detection thresholds, and warning algorithm for a particular deployment, using digital device 420. Second logic diagram 501 also assumes a forklift has an associated proximity tag.

A wide variety of alternate algorithms are possible, so the logic diagrams of FIG. 5A and FIG. 5B should be interpreted as illustrative and not limiting. For instance, applicants accommodate a four sensor algorithm for four way intersections, as well as an expert mode in which users may custom configure their own algorithms.

### Directive, Electrically-Small Antenna (DESA) Arrays

Antennas for use with NFER systems are electrically-small, typically much smaller than the wavelength. For instance, an NFER system operating at 1 MHz with a wavelength λ=300 m may employ antennas about 30 cm in dimension (λ/1000) or smaller. These electrically small antennas typically exhibit omnidirectional or dipole-like patterns. Applicant's “Directive electrically-small antenna system and method,” (Ser. No. 13/436,956, filed Apr. 1, 2012) presents further antennas of use in conjunction with a low-frequency, near-field proximity detection or location system. This application is incorporated in its entirety by reference.

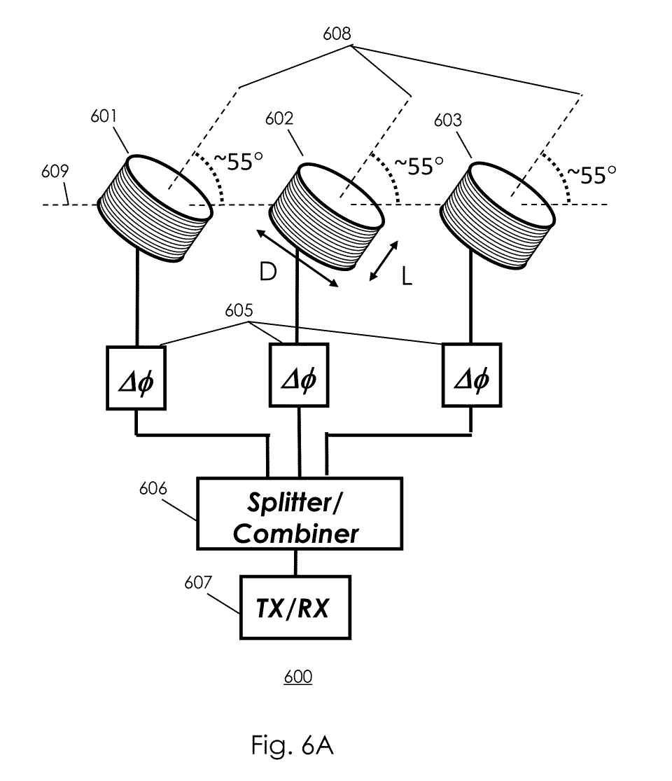

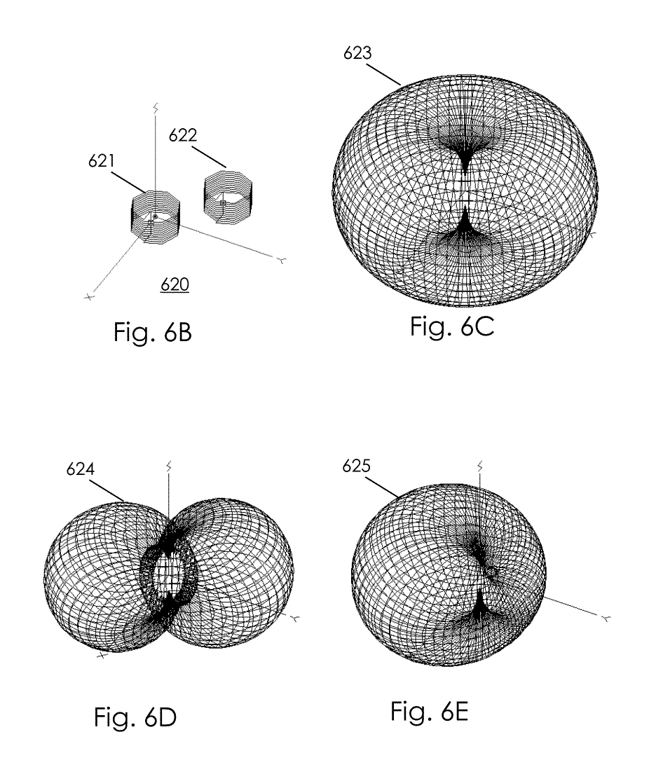

FIG. 6A shows a three element directional electrically-small antenna array 600. Three element directional electrically-small antenna array 600 further comprises a first magnetic element 601, a second magnetic element 602, a third magnetic element 603, (collectively “the elements”), a plurality of phase shifters 605, a splitter/combiner 606, and a transceiver 607. The elements are arranged with respective loop axes 608 inclined in a common plane at an angle of about 55 deg with respect to a common axis 609. This arrangement minimizes the mutual coupling between a plurality of antennas so arranged (see, for instance, Hazeltine, U.S. Pat. No. 1,577,421, issued Mar. 26, 1926). In a preferred embodiment, the elements are further characterized by a diameter (D) and a length (L) in a ratio D:L of approximately 3:1. This ratio optimizes performance for a given volume sphere occupied by the antenna. In alternate embodiments, three element directional electrically-small antenna array 600 may include fewer or additional elements phased and combined so as to achieve a wide variety of superdirective patterns. Also in alternate embodiments, the elements may further include ferrite loading.

FIG. 6B presents a two element directional electrically-small antenna array 620. The two element directional electrically-small antenna array 620, comprises a first element 621 and a second element 622 (collectively, “the elements”). For purposes of illustration and simulation using Numerical Electromagnetic Code (NEC), the elements are implemented as eleven turn loops about D=1 m in diameter and L=30 cm long separated by just over 1 m and arranged according to the Hazeltine geometry of FIG. 6A.

FIG. 6C depicts an in-phase pattern for the two element directional electrically-small antenna array 620. The in-phase pattern is dipole pattern 623.

FIG. 6D provides an opposing phase pattern for the two element directional electrically-small antenna array 620. Phasing the elements out of phase (i.e. a 180 degree phase difference with respect to each other) yields the opposing-phase pattern, a quadrupole or double-lobed pattern 624.

FIG. 6E displays an end-fire phase pattern for the two element directional electrically-small antenna array 620. The end fire phase condition phases the elements almost out of phase with each other, but offset by the phase distance corresponding to the distance between the elements so as to achieve a cancellation in a particular angle of arrival. The end-fire phase pattern is a unidirectional or cardiod-like pattern 625. By varying phasing in an electrically small antenna array, a variety of useful directive antenna patterns are achievable to optimize performance for a particular application. A directive electrically small antenna array may replace an individual receive antenna for a NFER or other receiver, particularly one operating with near-field or low frequency wireless signals.

### Motion and Proximity Detection Using Signals of Opportunity

In a preferred embodiment, motion detection and proximity detection for a selective proximity detection system are instantiated in separate systems. This has the advantage of detecting pedestrians without those pedestrians being associated with a proximity tag. An interesting alternative embodiment employs changes in the signal strength of scattered ambient signals so as to provide proximity detection and location information for a passive target such as a pedestrian.

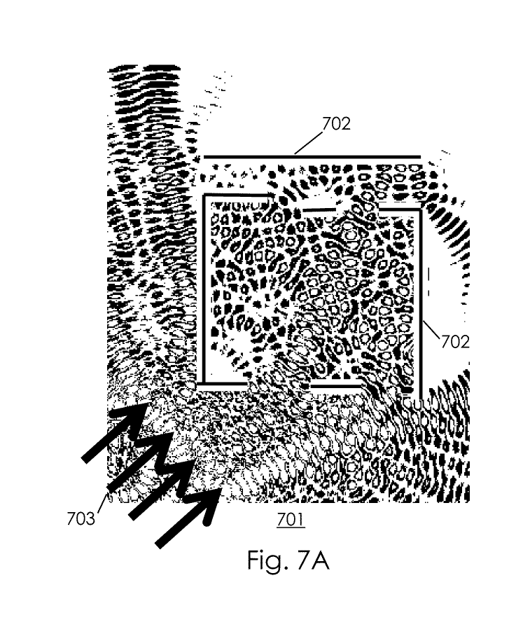

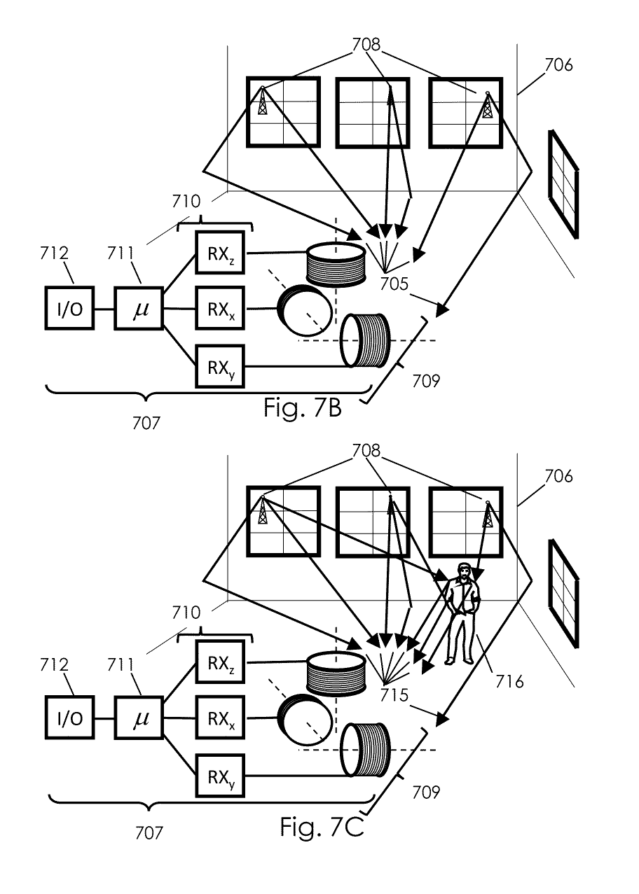

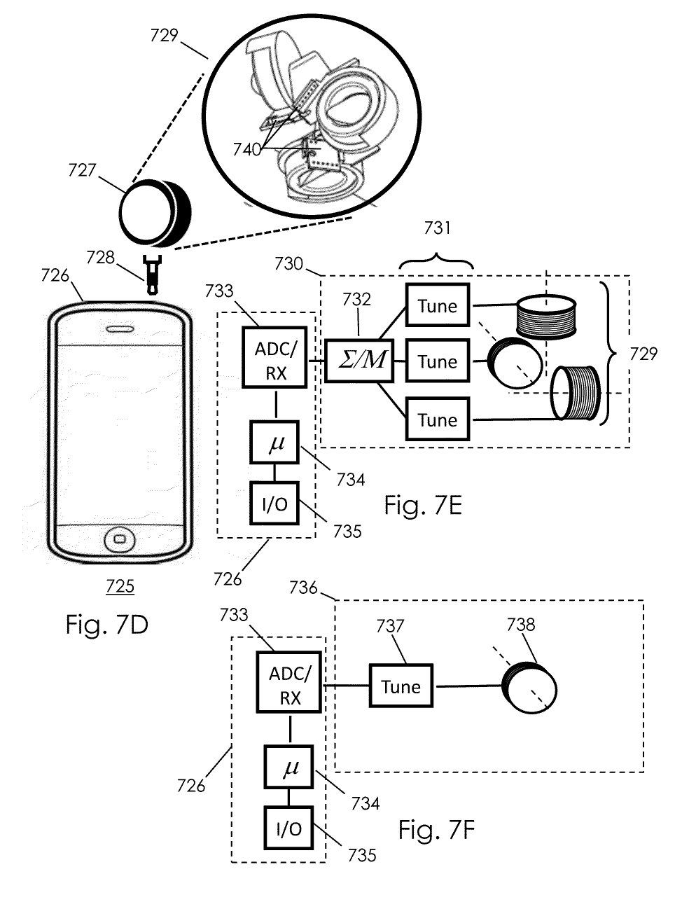

FIG. 7A shows a simulation 701 of radio waves interacting with a notional structure 702. The simulation 701 was implemented using the Loughborough University Wave Lab App for Android. A line of sources emulate a wave front incident from the direction indicated by arrows 703. Standing wave nodes, and antinodes as well as diffraction behavior are evident in the results. The precise nature of the standing wave pattern depends upon the geometry, arrangement, and idiosyncrasies of the scatters—in this case the notional structure 702. The standing wave pattern in the simulation 701, exhibits nodes and antinodes with characteristic separation distances on the order of a half wavelength. If additional scatterers were introduced to the propagation environment, the standing wave pattern would change and that change in signal amplitude in the standing waves of a plurality of signals can be associated with a proximity detection or location solution.

The inventors have discovered that FM broadcast band (88 MHz-108 MHz) signals are well-suited to this application. These FM broadcast band signals may be transmitted by an FM broadcast station, by a low-power transmitter operating in or around the FM broadcast band, or other source of RF signals whose frequencies are within or near the FM broadcast band. Their nominally 3 m wavelengths resonate strongly with scatterers about one half wavelength (˜1.5 m) in length. This is approximately the height of a typical person. In a preferred embodiment FM broadcast-band signals-of-opportunity may be employed. In alternate embodiments, signals-of-opportunity may be supplemented by or replaced by signals from beacons deliberately added or introduced to an environment within which a motion and proximity detection system might operate.

Applicants recently discovered that AM broadcast band signals are characterized by “near field” behavior, even many wavelengths away from the transmission tower. These localized near-field signal characteristics provide the basis for a “Method and apparatus for determining location using signals-of-opportunity” (Ser. No. 12/796,643, filed Jun. 8, 2010, now U.S. Pat. No. 8,018,383 issued Sep. 13, 2011). The techniques therein disclosed enable an RTLS comprising a mobile tag receiver employing signals-of-opportunity to determine precise location or position. Applicants noted that this signal-of-opportunity location approach could enable a suitable Locator-Receiver to determine its own position with respect to scattered FM band signals. More generically, passive receiver tag RTLS employing an uncooperative signal is described in Applicant's co-pending “Near-field electromagnetic location system and method,” (Ser. No. 12/977,067, filed Dec. 23, 2010) along with other improvements in the RTLS arts.

The embodiment of a selective proximity detection system hereinafter disclosed enables detection and location of a passive scatterer, such as a person, by exploiting the interaction of the person with the standing wave behavior in the area within several wavelengths of the Locator. In this discussion, the term “Locator” or “Locator-Receiver” may be employed to refer to a selective proximity detection system (PDS) hereinafter described employing detection and location of a passive scatterer of ambient RF signals.

FIG. 7B presents a sketch of radio waves 705 interacting with a structure 706 and then being received by a locator 707. The radio waves 705 originate from a plurality of sources or stations 708 and interact with structure 706 to yield a standing wave pattern like that of simulation 701. Locator 707 receives radio waves 705. In a preferred embodiment, locator 707 employs three mutually orthogonal magnetic antennas 709 with associated receivers 710 to capture and characterize three signals associated with each of the plurality of sources 708. The three mutually orthogonal magnetic antennas 709 are preferentially in a minimum coupling configuration, as further described in Applicant's co-pending “Minimum coupling symmetric array,” application Ser. No. 14/313,932 filed Jun. 24, 2014. This application is incorporated by reference. A microprocessor 711 gets signal information from associated receivers 710 and can process the data to deliver an alert, or pass on data or alerts via input-output (I/O) block 712.

FIG. 7C depicts a sketch of radio waves 715 interacting with a structure 706 and a scatterer 716 and then being received by a locator 707. The presence of the scatterer 716 alters radio waves 715 from the radio waves 705 in FIG. 7B where there was no scatterer. Locator 707 receives radio waves 715 including the impact of scatterer 716. If signals captured by locator 707 associated with radio waves 705 in the case of FIG. 7B differ measurably from the signals captured by locator 707 associated with radio waves 715 in the case of FIG. 7C, then microprocessor 711 can detect the proximity of scatterer 716 and relay the detection via I/O block 712. The impact of the scatterer depends generally upon the location and nature of the scatterer. For instance, a large piece of industrial equipment like a forklift will tend to exhibit greater scattering than a pedestrian. Also, scattering may vary in a distinctive fashion depending on location of a scatterer. A locator may exploit this phenomenon to determine the scatterer's location using an RF fingerprinting or other location algorithm relative to a calibration data set as further described in the this application.

FIG. 7D provides an alternate embodiment selective proximity detection system 725 comprising a smart phone 726 and an antenna 727. Antenna 727 includes an audio jack 728 to provide an electrical connection to smart phone 726. Many smart phones have FM radio receivers (operating over 88-108 MHz) that employ a headphone cable as an antenna, so antenna 727 exploits this common feature.

In a preferred embodiment, antenna 727 further includes a minimum coupling orthogonal magnetic antenna array 729 as further described in Applicant's co-pending “Minimum coupling symmetric array,” application Ser. No. 14/313,932 filed Jun. 24, 2014. This application is incorporated by reference. Orthogonal magnetic antenna array 729 has the advantage of enabling a single channel receiver to capture all three orthogonal field components if used in conjunction with a multiplexer. Alternatively, the inputs of the three element in orthogonal magnetic antenna array 729 may be summed to achieve a good approximation to the total field amplitude and total signal power. A smart phone 726 typically has an analog-digital convertor (ADC) capability that can output audio frequency signals to the headphone jack to enable either varactor tuning or multiplexing. An averaged pulse width modulated (PWM) signal can yield a desired varactor tuning voltage, for instance. Orthogonal magnetic antenna array 729 further includes a plurality of interface PCBs 730 to support suitable tuning or multiplexing circuits.

In alternate embodiments, antenna 727 may comprise a single, larger antenna element. For instance, a 25 mm diameter magnetic antenna with a bandwidth of 250 kHz, adequate to detect a single FM radio signal, will exhibit an antenna gain of about −20 dBi to −24 dBi across the 88 MHz-108 MHz band. This is sufficient to detect most local station signals. A 12.5 mm diameter antenna with comparable bandwidth will be characterized by about −29 dBi to −33 dBi gain.

An untuned antenna will exhibit broader bandwidth but lower sensitivity. A 25 mm diameter antenna with 20 MHz bandwidth centered at 98 MHz so as to capture the entire FM band will exhibit −39 dBi-−43 dBi gain. A comparable 12.5 mm diameter antenna will have −48 dBi to −52 dBi gain. Ferrite loading may enhance the gain to a degree. Even these low gains are likely to be adequate to detect strongly local FM broadcast signals, however. As usual, there exists an engineering tradeoff between cost and complexity on the one hand and performance on the other.

FIG. 7E offers a first block diagram of an alternate embodiment selective proximity detection system 725 comprising a smart phone 726 and an antenna system 730. Antenna system 730 includes orthogonal magnetic antenna array 729, tuners 731 and summer 732. In alternate embodiments, the summer 732 may be replaced by a multiplexer. Smart phone 726 further comprises ADC and Receiver (RX) 733, microprocessor 734 and Input/Output (I/O) module 735.

FIG. 7F displays a second alternate block diagram of an alternate embodiment selective proximity detection system 725 comprising a smart phone 726 and an antenna system 736. Antenna system 736 further comprises tuner 737 and ferrite loaded magnetic loop antenna 738.

### Alternate Selective Proximity Detection Processes

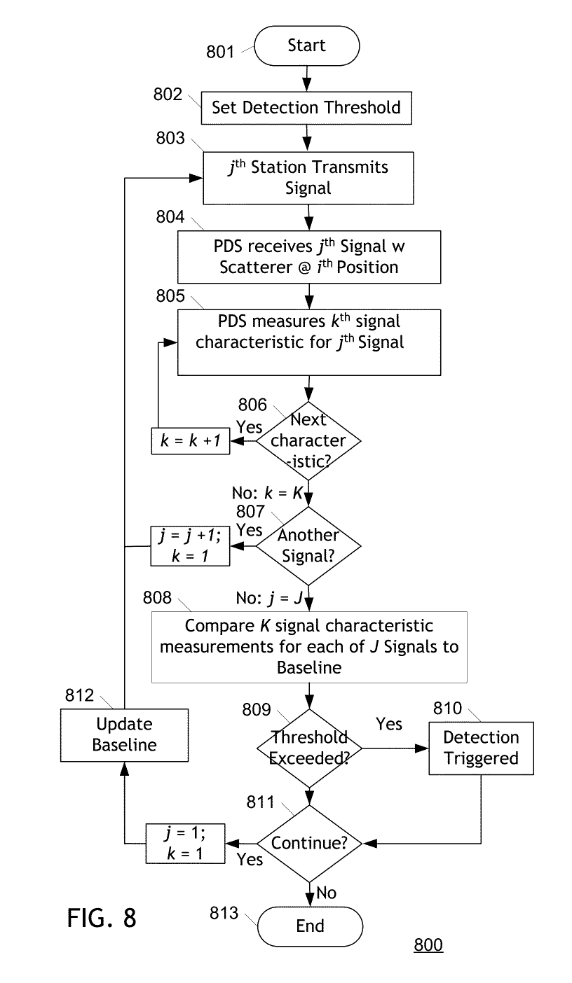

FIG. 8 presents a first alternate embodiment process flow diagram 800 for a selective proximity detection system. Process flow commences at start block 801. The steps depicted in the flowcharts herein are not necessarily performed in the order drawn. Process flow continues with setting a detection threshold in block 802. A detection threshold is the level at which a signal characteristic may vary from a baseline level before a detection is triggered. A detection threshold may be set on a signal characteristic by signal characteristic basis or a single threshold may be set to compare against the collective deviation of all signals detected. A detection threshold may be adjustable by a user, preset and fixed, or dynamically varying depending on the level and variation of received signals. The user may be an end user or customer, or an engineer or researcher determining appropriate threshold levels for particular scatterers and deployment settings. A detection threshold may be an absolute value or a percent or ratio relative to a baseline value.

A preferred embodiment employs multiple detection thresholds, allowing a selective proximity detection system to distinguish between scatterers. For instance, a forklift or large piece of industrial equipment will tend to have greater scattering than an individual pedestrian. Thus a plurality of detection thresholds can allow a proximity detection system to be selective and discriminate between a range of potential scatterers.

Process flow continues with transmitting a signal by the j^{th} station in block 803. In a preferred embodiment a station is an FM broadcast station, although in alternate embodiments signals from other sources may supplement or replace FM broadcast signals.

Process flow continues with a proximity detection system (PDS) receiving a j^{th} signal from the j^{th} station in block 804. The j^{th} signal may include a combination of direct and multipath components depending on scattering from structures, people, or other scatterers. Process flow then continues at block 805 with a PDS measuring a k^{th} signal characteristic from the j^{th} signal. Signal characteristics may include total power, amplitude of individual components received by orthogonal antennas, or phase or phase difference characteristics.

Process flow continues in decision block 806. If there is another characteristic for the PDS to evaluate, the PDS increments k to k+1 and continues at block 805. If there is not another characteristic of the j^{th} signal for the PDS to measure, process flow continues at decision block 807. If there is another signal for the PDS to evaluate, the PDS increments j to j+1 and continues at block 803. If there is not another signal for the PDS to receive, process flow continues at block 808.

In process block 808, a PDS compares K signals characteristics from each of the J signals to a baseline value. A baseline value may be a user set level, a hardwired level, or in a preferred embodiment a rolling average of received signal strength. In a preferred embodiment, a comparison calculates the sum of the absolute values of the deviations of the currently received signal characteristic values and compares them to the baseline obtained through a rolling average.

Process flow continues in decision block 809. If the result of the comparison of block 808 does not exceed the threshold of block 802, process flow continues in decision block 811. If the result of the comparison of block 808 exceeds the threshold, then process flow continues in block 810 with triggering of a detection by a PDS.

Triggering may be connected with a wide variety of useful actions including, but not limited to, sending an alert to a remote user, triggering a camera to record video or still photos, sounding an audio or visual alarm, or recording details of the triggering event in a database. A PDS may take such action or communicate data to another device.

In a preferred embodiment, multiple detection thresholds may have been set by a user in block 802, allowing a PDS to evaluate the scattering and distinguish between a range of potential scatterers, such as a discrimination between a pedestrian 414 and a forklift 415. The proximity detection system may employ a plurality of thresholds to determine an appropriate alert for a plurality of scatterers.

Process flow continues in decision block 811. If the PDS continues the process, process flow continues back at block 803 with transmission of a signal by the j=1 station. Otherwise the process terminates at end block 813. A first alternate embodiment process flow determines presence of a scatterer by receiving and measuring ambient RF signals.

### Passive Real-Time Location of Scatterers

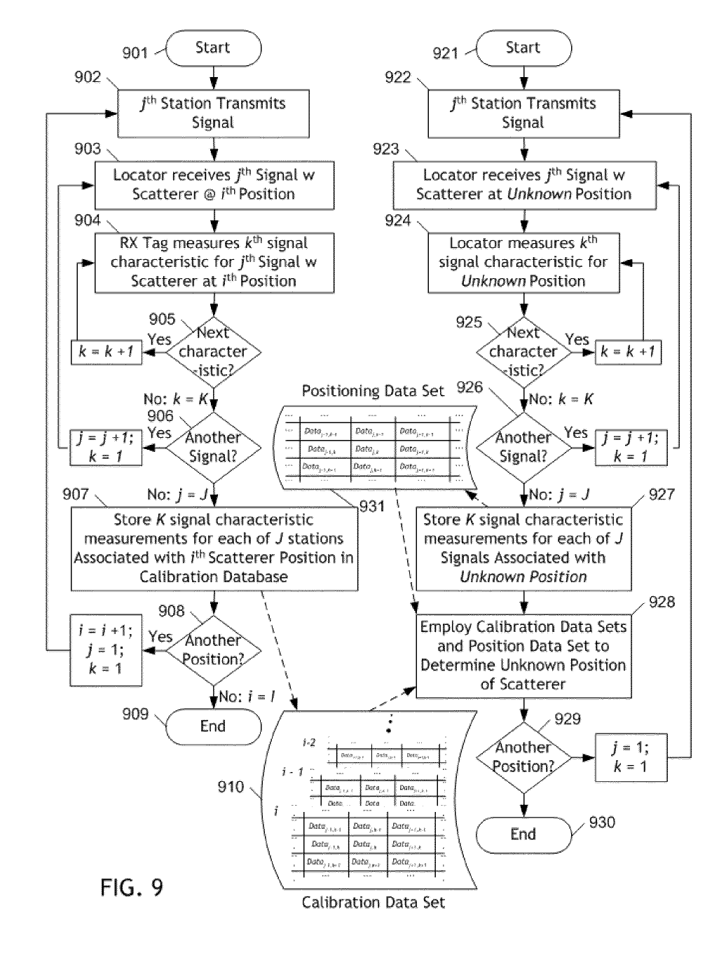

FIG. 9 presents a second alternate embodiment process flow diagram 900 for a selective proximity detection system. The second alternate embodiment process flow presents a method for selective proximity detection involving determining a location of a scatterer. The proximity detection system (or equivalently, locator-receiver) will localize a scatterer to an accuracy on the order of about a half-wavelength or about 1.5 m for typical FM broadcast band frequencies.

The second alternate embodiment process flow diagram 900 illustrates a representative “calibration mode” on the left side and a representative “location detection mode” on the right side. In “calibration mode,” process flow commences at start block 901. The steps depicted in the flowcharts herein are not necessarily performed in the order drawn.

The process flow continues with the j^{th} station (or equivalently, beacon) transmitting a calibration transmission in block 902. In preferred embodiments, the station is an FM broadcast station, and the signal is a direct signal, a scattered signal, or a combination of direct and scattered signals originating at the FM broadcast station.

Then in block 903, the Locator (for instance, proximity detection system 707 or proximity detection system 725) receives the calibration transmission with the scatterer (for instance, person 716) in the i^{th} position. The Locator measures the k^{th} signal characteristic of the j^{th} signal with the scatterer at the i^{th} position in block 904. In the most simple embodiments, K=1 and the signal characteristic is the total power. In alternate embodiments, K=3 and the signal characteristics are the three orthogonal signal amplitudes or powers. In still further alternate embodiments, K=6 inclusive of the three amplitudes from three orthogonal antennas and the three phase differences between signals from the three orthogonal antennas. Additional characteristics of the signals may be captured through a demodulation process. In typical embodiments, J=6 to 20 depending on the availability of signals, although with reduced accuracy a single locator-receiver may suffice determine its unknown position from a single signal (i.e. J=1) if a Locator employs K=6 signal characteristics. In a preferred embodiment the calibration transmission is a near-field signal dominated by the near-field scatter and standing waves of a distant FM broadcast station as depicted in simulation 701 of FIG. 7A.

The process flow continues with decision block 905. If all K characteristics have not yet been measured, then the process continues back at block 904 with measuring the next, i.e. (k+1)^{th}, characteristic. Otherwise, the process continues with decision block 906. If additional calibration transmissions (or signals) are available, the process may continue at block 903 with the Locator receiving a calibration transmission from the (j+1)^{th} station with the scatterer at the at the i^{th} position. If the Locator has measured all J available signals, then the process continues at block 907 with storing K signal characteristic measurements for each of the J station (or equivalently beacon) signals with the scatterer at the i^{th} position in the plurality of Calibration Data Sets 910. An associator or person performing the calibration provides truth data for the calibration mode allowing a processor or information handling system (IHS) to correlate the Calibration Data Set with the known i^{th} scatterer position in block 907. Additional data or measurements including orientation or other sensor data may also be associated with the i^{th} position in the plurality of Calibration Data Sets 910.

If all I desired scatterer positions have not yet been characterized, then the process continues back at block 902 with the first (j=1) station transmitting a calibration transmission to be received by a Locator with the scatterer at the (i+1)^{th} position. Otherwise, the calibration mode process terminates in End Block 909.

A “location detection mode” begins on the right side of the process flow diagram with Start Block 921. The steps depicted in the flowcharts herein are not necessarily performed in the order drawn. The process flow continues with the j^{th} station transmitting a location transmission in block 922.

Then the process flow continues in block 923 with the Locator receiving the j^{th} station's location transmission with the scatterer at the unknown position. The Locator measures the k^{th} signal characteristic of the j^{th} station signal with the scatterer at the unknown position in block 924.

The process flow continues with decision block 925. If all K characteristics have not yet been measured, then the process continues back at block 924 with measuring the (k+1)^{th} characteristic. Otherwise, the process continues with decision block 926. If additional signals are available, the process may continue at block 923 with the Locator receiving a location transmission from the (j+1)^{th} station while the scatterer is at the unknown position. If all J available signals have been measured, then the process continues at block 927 with storing K signal characteristics for each of the J station's location transmissions in Positioning Data Set 931. Positioning Data Set 931 thus includes signal characteristics of beacon signals received by the Locator with the scatterer at the unknown position. In a preferred embodiment the location transmission is a near-field signal of a nearby station, or standing waves or multipath signals of a distant station. Also, nothing in this disclosure should be construed so as to require the Locator employed in the location determination mode to be the same Locator as that employed in the calibration mode. In practice, many different yet functionally equivalent Locators may share a common calibration data set. Similarly, multiple Locators may be employed in generating a particular calibration data set.

The process flow continues in block 928 with employing Calibration Data Sets 910 and Positioning Data Set 931 to determine the unknown position of the scatterer. If another position needs to be determined, then the process continues back at block 922 with the Transmit Tag transmitting a location transmission from another unknown position or location. Otherwise, the location determination mode process terminates in End Block 930.

Applicants have developed a variety of algorithms for comparing Calibration Data Sets 910 and Positioning Data Set 931 to determine the unknown position of a transmitter or a receiver in a near-field or multipath heavy propagation environment. Near-Field Electromagnetic Ranging (NFER) technology offers a wireless physical layer optimized for real-time location in the most RF hostile settings. NFER® systems exploit near-field behavior within about a half wavelength of a tag transmitter to locate a tag to an accuracy of 1-3 ft, at ranges of 60-200 ft, all at an infrastructure cost of $0.50/sqft or less for most installations. NFER® systems operate at low frequencies, typically around 1 MHz, and long wavelengths, typically around 300 m.

Low frequency signals penetrate better and diffract or bend around the human body and other obstructions. This physics gives NFER® systems long range. There's more going on in the near field than in the far field. Radial field components provide the near field with an extra (third) polarization, and the electric and magnetic field components are not synchronized as they are for far-field signals. Thus, the near field offers more trackable parameters. Also, low-frequency, long-wavelength signals are resistant to multipath. This physics gives NFER® systems high accuracy. Low frequency hardware is less expensive, and less of it is needed because of the long range. This makes NFER® systems more economical in more difficult RF environments.

Near field electromagnetic ranging was first fully described in applicant's “System and method for near-field electromagnetic ranging” (Ser. No. 10/355,612, filed Jan. 31, 2003, now U.S. Pat. No. 6,963,301, issued Nov. 8, 2005). This application is incorporated in entirety by reference. Some of the fundamental physics underlying near field electromagnetic ranging was discovered by Hertz [Heinrich Hertz, Electric Waves, London: Macmillan and Company, 1893, p. 152]. Hertz noted that the electric and magnetic fields around a small antenna start 90 degrees out of phase close to the antenna and converge to being in phase by about one-third to one-half of a wavelength. This is one of the fundamental relationships that enable near field electromagnetic ranging. A paper by one of the inventors [H. Schantz, “Near field phase behavior,” 2005 IEEE Antennas and Propagation Society International Symposium, Vol. 3A, 3-8 July, 2005, pp. 237-240] examines these near-field phase relations in further detail. Link laws obeyed by near-field systems are the subject of another paper [H. Schantz, “Near field propagation law & a novel fundamental limit to antenna gain versus size,” 2005 IEEE Antennas and Propagation Society International Symposium, Vol. 3B, 3-8 July, 2005, pp. 134-137]. In addition to an active RTLS tag (or fixed locator—mobile beacon) architecture, the teachings of U.S. Pat. No. 6,963,301 encompass a passive location tag (or fixed beacon—mobile locator) architecture. In this architecture, the passive location tag (or passive RTLS tag) is a receiver that may be incorporated or associated with a vehicle or person to provide position information from signals emitted by fixed transmit beacons. A beacon may be an uncooperative source of electromagnetic radiation, like a signal from an AM broadcast station, an FM broadcast station or other signal-of-opportunity. In the sense taught by Applicants, a “passive RTLS tag” is passive in the sense that it does not emit signals in the process of obtaining location data, rather it receives and characterizes signals so as to determine location of an associated mover. Determination of location may be performed either locally (within the passive RTLS tag) or remotely (by conveying signal characterization data to a remote server for location determination).

Complicated propagation environments do tend to perturb the near-field phase relations upon which NFER® systems rely. Applicants have overcome this problem using calibration methods described in “Near-field electromagnetic positioning system and method” (Ser. No. 10/958,165, filed Oct. 4, 2004, now U.S. Pat. No. 7,298,314, issued Nov. 20, 2007). Additional calibration details are provided in applicant's “Near-field electromagnetic positioning calibration system and method” (Ser. No. 11/968,319, filed Nov. 19, 2007, now U.S. Pat. No. 7,592,949, issued Sep. 22, 2009). Still further details of this calibration are provided in applicant's co-pending “Near-field electromagnetic calibration system and method” (Ser. No. 12/563,960 filed Sep. 21, 2009, now U.S. Pat. No. 7,859,452, issued Dec. 28, 2010). Systems and methods of calibration and determination of location pioneered in these applications are relevant to the present invention. These applications are all incorporated in entirety by reference.

Applicant's unique algorithms enable innovative techniques for displaying the probability density and other aspects of location information, as described in applicant's “Electromagnetic location and display system and method,” (Ser. No. 11/500,660, filed Aug. 8, 2006, now U.S. Pat. No. 7,538,715, issued May 26, 2009).

Further, the phase properties of near-field signals from orthogonal magnetic and other multiple antenna near-field transmission signals enable additional phase comparison states that can be used for location and communication, as described in applicant's co-pending “Multi-state near-field electromagnetic system and method for communication and location,” (Ser. No. 12/391,209, filed Feb. 23, 2009, now U.S. Pat. No. 8,253,626, issued Aug. 28, 2012).

Near-field electromagnetic ranging is particularly well suited for tracking and communications systems in and around standard cargo containers due to the outstanding propagation characteristics of near-field signals. This application of NFER® technology is described in applicant's “Low frequency asset tag tracking system and method,” (Ser. No. 11/215,699, filed Aug. 30, 2005, now U.S. Pat. No. 7,414,571, issued Aug. 19, 2008).

Applicants have also discovered that near-field electromagnetic ranging works well in the complicated propagation environments of nuclear facilities and warehouses. An NFER® system provides the RTLS in a preferred embodiment of applicants' co-pending “System and method for simulated dosimetry using a real-time location system” (Ser. No. 11/897,100, filed Aug. 29, 2007, now abandoned). An NFER® system also provides the real-time location system in a preferred embodiment of applicants' “Asset localization, identification, and movement system and method” (Ser. No. 11/890,350, filed Aug. 6, 2007, now U.S. Pat. No. 7,957,833 issued Jun. 7, 2011) and in applicants' “Inventory control system and method” (Ser. No. 13/153,640, filed Jun. 6, 2011, now U.S. Pat. No. 8,326,451 issued Dec. 4, 2012).

Applicants also discovered that a path calibration approach can yield successful location solutions particularly in the context of first responder rescues, as detailed in applicant's “Firefighter location and rescue equipment” (Ser. No. 13/021,711, filed Feb. 4, 2011).

All these applications are incorporated in entirety by reference.

### CONCLUSION

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

While various embodiments of the present invention have been described above, it should be understood that they have been presented by way of example only, and not limitation. One should understand that numerous variations may be made by one skilled in the art based on the teachings herein. Thus, the breadth and scope of the present invention should not be limited by any of the above-described exemplary embodiments, but should be defined only in accordance with the following claims and their equivalents.

We claim:

1. A selective proximity detection system comprising:
at least one proximity tag,
a plurality of sensor nodes, each of the plurality of sensor nodes further comprising a proximity detector, a motion detector, and a datalink conveying proximity detection data and motion detection data,
at least one alert node further comprising a microprocessor and a warning device, the alert node employing the warning device to provide a plurality of alert responses, and the microprocessor selecting from among said plurality of alert responses based upon the proximity detection data and the motion detection data.

2. The selective proximity detection system of claim 1 in which the motion detector is an infrared detector.

3. The selective proximity detection system of claim 1 in which the proximity detector is an NFER receiver and said proximity tag is a NFER tag transmitter.

4. The selective proximity detection system of claim 3 in which the NFER receiver employs a directional electrically-small antenna array.

5. The selective proximity detection system of claim 1 in which the proximity detector is normally off until the microproceesor turns the proximity detector on in response to a motion detection by the motion detector.

6. The selective proximity detection system of claim 1 in which the motion detector determines presence of a scatterer by the steps of:
1) setting, by a user, a plurality of detection thresholds,
2) transmitting, by a station, a signal,
3) receiving, by the proximity detection system, the signal
4) measuring, by the proximity detection system, a plurality of received signal characteristics,
5) comparing, by the proximity detection system, the plurality of received signal characteristics with a baseline value, and
6) employing, by the proximity detection system, the plurality of thresholds to determine an appropriate alert.

7. The selective proximity detection system of claim 6 in which the signal is an FM broadcast band signal.

8. The selective proximity detection system of claim 7 in which the plurality of detection thresholds include thresholds for a pedestrian and a forklift.

9. The selective proximity detection system of claim 1 in which the alert node incorporates the warning device.

10. The selective proximity detection system of claim 1 in which the warning device is remote.

11. The selective proximity detection system of claim 1 in which the warning device comprises a plurality of LED light strips.

12. The selective proximity detection system of claim 1 in which a remote digital device can configure or monitor the selective proximity detection system.

13. The selective proximity detection system of claim 1 in which a remote digital device can configure and monitor the selective proximity detection system.

14. A method for selective proximity detection by a proximity detection system comprising the steps of:
1) setting, by a user, a plurality of detection thresholds,
2) transmitting, by a station, a signal,
3) receiving, by the proximity detection system, the signal
4) measuring, by the proximity detection system, a plurality of received signal characteristics,
5) comparing, by the proximity detection system, the plurality of received signal characteristics with a baseline value, and
6) employing, by the proximity detection system, the plurality of thresholds to determine an appropriate alert.

15. The method for selective proximity detection by a proximity detection system disclosed in claim 14 wherein the signal is an FM broadcast band signal.

16. The method for selective proximity detection by a proximity detection system disclosed in claim 14 in which the plurality of detection thresholds include thresholds for a pedestrian and a forklift.

17. A method for selective proximity detection involving determining a location of a scatterer by the steps of:
1) generating a plurality of calibration data sets, each calibration data set of said plurality of calibration data sets generated by:
a) transmitting, by a station, a calibration transmission,
b) receiving, by a locator-receiver, the calibration transmission,
c) measuring, by the locator-receiver, a plurality of received signal characteristics of the calibration transmission to generate said calibration data set,
d) associating, by an associator, said calibration data set with the known position of a scatterer,
2) generating a positioning data set, said positioning data set generated by:
a) transmitting, by the station, a location transmission,
b) receiving, by the locator-receiver, the location transmission,
c) measuring, by the locator-receiver, a plurality of received signal characteristics of the location transmission to generate said positioning data set associated with the unknown position,
and
3) determining, by an information handling system, said unknown position of a scatterer based on a comparison of said plurality of calibration data sets to said positioning data set.

18. The method for selective proximity detection involving determining a location of a scatterer recited in claim 17 in which the calibration transmission and the location transmission are FM broadcast band signals.

19. The method for selective proximity detection involving determining a location of a scatterer recited in claim 18 in which said received signal characteristics include a plurality of signal amplitudes.
